(19) United States
(12) Patent Application Publication
(10) Pub. No.: US 2025/0200496 A1
(43) Pub. Date: Jun. 19, 2025

(54) ELECTRONIC APPARATUS, COMPUTER-READABLE MEDIUM AND DISPATCH-ORDER GENERATION METHOD FOR LOGISTICS MANAGEMENT

(71) Applicant: WPG Holdings Co., Ltd., Taipei City (TW)

(72) Inventors: TZU-WEI LI, Taipei City (TW); I-LUN LEE, Taipei City (TW); CHUN-WEI CHANG, Taipei City (TW); PIN-SEN SUNG, Taipei City (TW)

(21) Appl. No.: 18/981,127

(22) Filed: Dec. 13, 2024

Related U.S. Application Data
(60) Provisional application No. 63/610,647, filed on Dec. 15, 2023.

(51) Int. Cl. G06Q 10/0832; G06Q 10/087

(52) U.S. Cl. CPC G06Q 10/0832; G06Q 10/087

(57) ABSTRACT

An electronic apparatus inspects a delivery order by a plurality of conditional modules of an inspection configuration file according to an inspection sequence which the conditional modules correspond to. The electronic apparatus performs dispatch-order automation processing on the delivery order when the delivery order passes the inspections of all of the conditional modules. The electronic apparatus stops using the remaining conditional modules to inspect the delivery order every time when the delivery order fails the inspection of any of the conditional modules in the inspection sequence.

### PRIORITY

This application claims priority to U.S. Provisional Patent Application No. 63/610,647 filed on Dec. 15, 2023, the disclosure of which is incorporated herein by reference in its entirety.

### FIELD

The present invention relates to a logistics management technology. More specifically, the present invention relates to an electronic apparatus, a computer-readable medium and a dispatch-order generation method for logistics management.

### BACKGROUND

For automated logistics management, a logistics management system will automatically generate a corresponding dispatch order for each delivery order only after the delivery order has passed inspections of multiple conditions. The delivery order records all kinds of information about the goods of customers, while the dispatch order records all kinds of information about the dispatch of the goods of customers. Because the data formats of different types of delivery orders are different, and the contents of the data that need to be inspected are also different, the logistics management system must spend huge computing resources to deal with the inspection of delivery orders. With the increase of the number of inspection conditions, the burden of the logistics management system will also increase. Thus, it is particularly important to improve the efficiency of the logistics management system in inspecting delivery orders.

### SUMMARY

In order to overcome the above problems, the present invention provides an electronic apparatus for logistics management. The electronic apparatus may comprise a storage and a processor electrically connected with the storage. The storage may be configured to store a delivery order and data recorded therein and an inspection configuration file. The inspection configuration file may comprise a plurality of conditional modules, and the plurality of conditional modules correspond to an inspection order. The processor may be configured to inspect the delivery order by using the plurality of conditional modules of the inspection configuration file according to the inspection order. When the delivery order passes inspections of the plurality of conditional modules, the processor may be configured to perform dispatch-order automation processing on the delivery order. Every time when the delivery order fails an inspection of any of the plurality of conditional modules in the inspection order, the processor may be configured to stop using the remaining conditional modules to inspect the delivery order.

In order to overcome the above problems, the present invention further provides a computer-readable medium. The computer-readable medium, after being loaded into an electronic apparatus, may cause the electronic apparatus to execute the following instructions: inspecting a delivery order by using a plurality of conditional modules of an inspection configuration file according to an inspection order which the plurality of conditional modules correspond to; performing dispatch-order automation processing on the delivery order when the delivery order passes inspections of the plurality of conditional modules; and stopping using the remaining conditional modules to inspect the delivery order every time when the delivery order fails an inspection of any of the plurality of conditional modules in the inspection order.

In order to overcome the above problems, the present invention further provides a dispatch-order generation method executed by an electronic apparatus. The dispatch-order generation method may comprise the following steps: inspecting a delivery order by using a plurality of conditional modules of an inspection configuration file according to an inspection order which the plurality of conditional modules correspond to; performing dispatch-order automation processing on the delivery order when the delivery order passes inspections of the plurality of conditional modules; and stopping using the remaining conditional modules to inspect the delivery order every time when the delivery order fails an inspection of any of the plurality of conditional modules in the inspection order.

In the present invention, the traditional inspection conditions have been modulized into a plurality of conditional modules and integrated into an inspection configuration file, and each conditional module corresponds to a serial number to indicate the level of priority thereof in the inspection order. In addition, the proposed electronic apparatus uses the conditional modules of the inspection configuration file to inspect each delivery order in sequence according to the inspection order of the inspection configuration file, and every time when one delivery order fails the inspection of any of the plurality of conditional modules, the electronic apparatus stops using the remaining conditional modules to inspect the delivery order. Accordingly, the proposed electronic apparatus can screen out (filter out) the delivery order which is not suitable for automatic generation of a dispatch order as early as possible, which not only saves the computing resources of the logistics management system, but also improves the inspection efficiency of the delivery order. In other words, the proposed electronic apparatus, the proposed computer-readable medium and the proposed dispatch-order generation method indeed solve the above problems.

In addition, the modulizations of inspection conditions makes codes of inspection operation easy to manage and maintain, and because each conditional module can be developed, tested and maintained independently, the complexity of designing codes of each conditional module is also reduced. In addition, due to the modulizations of inspection conditions, the conditional modules can be easily adjusted or expanded without modifying all the codes on a large scale.

The above content provides a basic description of the present invention, including the technical problems to be solved by the present invention, the technical means adopted by the present invention and the technical effects achieved by the present invention, and various embodiments of the present invention will be further exemplified hereinafter.

### BRIEF DESCRIPTION OF THE DRAWINGS

FIG. 1 illustrates the basic architecture of an electronic apparatus for logistics management according to some embodiments of the present invention.

FIG. 2 illustrates the overall operation of the electronic apparatus described above.

FIG. 3 illustrates how the electronic apparatus described above divides the delivery order into a hot processing area and a cold processing area.

FIG. 4 illustrates how a computer-readable medium drives an electronic apparatus to execute instructions according to some embodiments of the present invention.

FIG. 5 illustrates a dispatch-order generation method according to some embodiments of the present invention.

### DETAILED DESCRIPTION

The following example embodiments are not intended to limit the claimed invention to specific environments, examples, applications, structures, processes, or scenarios. In the attached drawings, elements unrelated to the claimed invention are omitted from depiction. In the attached drawings, dimensions of and dimensional scales among individual elements are only provided as schematic exemplary examples, and are not intended to limit the claimed invention. Unless otherwise specified, the same element symbols may indicate the same elements.

Terminology described here is only for the ease of describing the content of the embodiments, and is not intended to be used to limit the claimed invention. Unless particularly and explicitly stated otherwise, the singular form “a/an” or “one” shall be regarded as including the plural form as well. Terms such as “comprising”, “including” and “having” are used to specify the presence of a feature, integer, step, operation, element, component and/or group stated after the terms, but do not exclude the presence or addition of one or more other additional features, integers, steps, operations, elements, components and/or groups. The term “and/or” is used to indicate any one or all combinations of one or more associated items listed. When used to describe elements, terms such as “first”, “second” and “third” are not intended to limit but only to distinguish these elements described. Thus, for example, a first element may also be named as a second element without departing from the spirit or scope of the claimed invention.

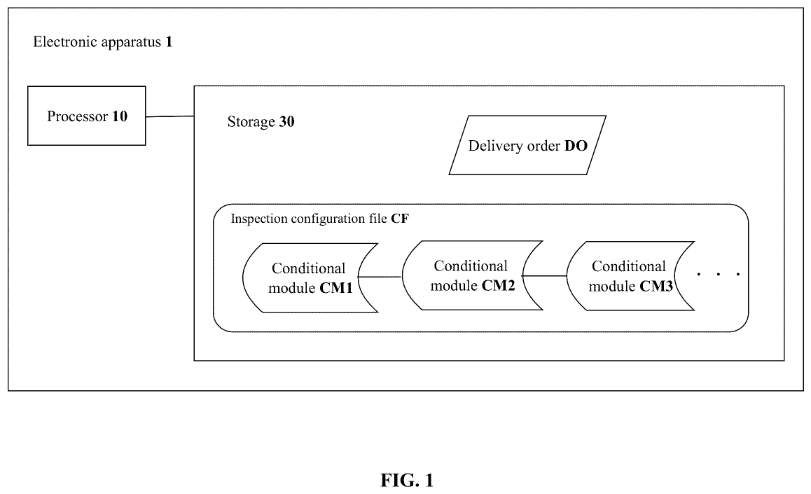

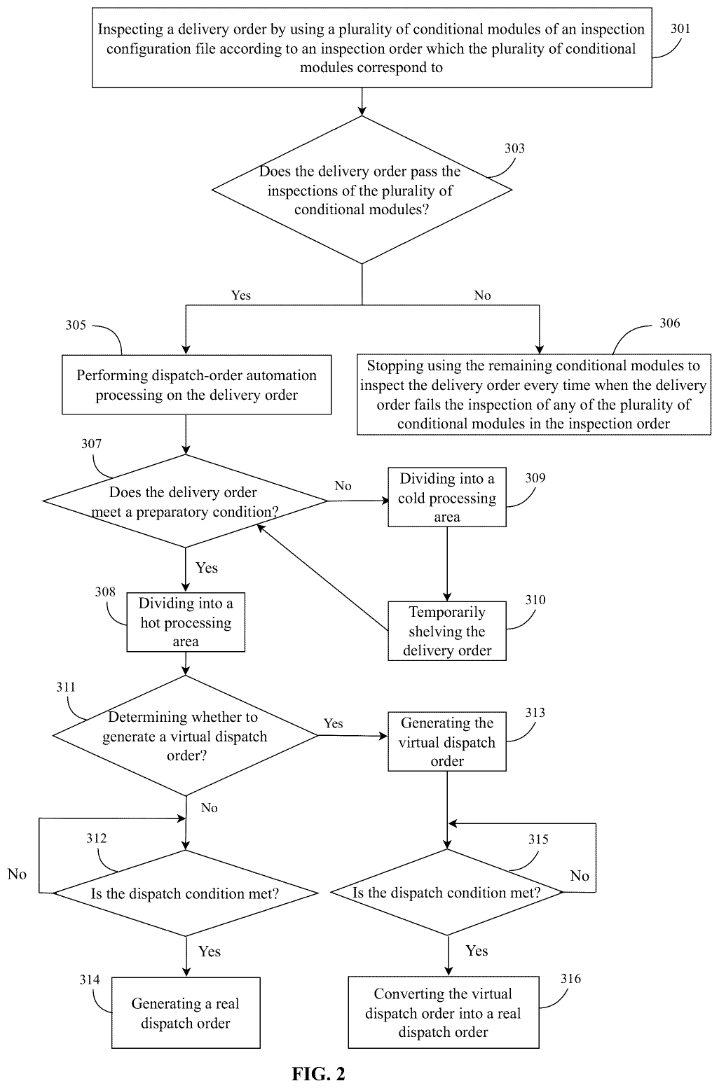

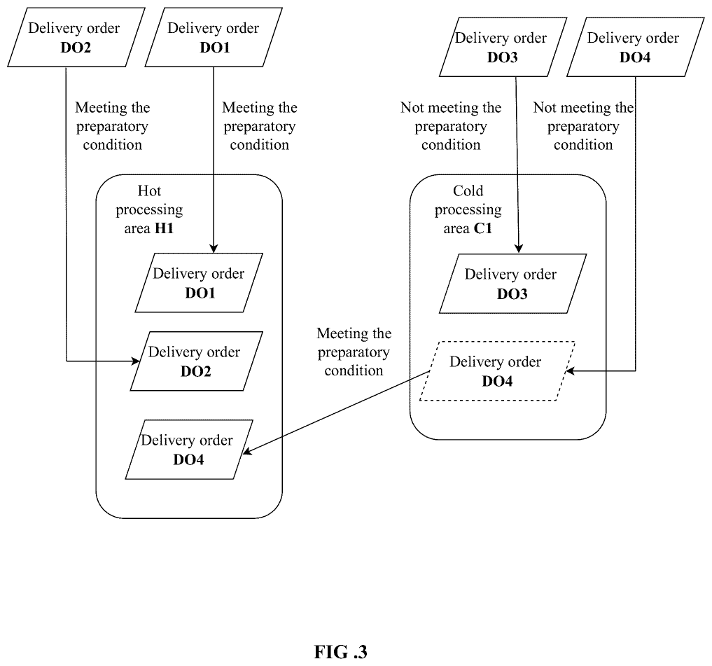

Some embodiments of the present invention relate to an electronic apparatus for logistics management (which is referred to as “an electronic apparatus 1” hereinafter). FIG. 1 illustrates the basic architecture of the electronic apparatus 1, while FIG. 2 illustrates the overall operation of the electronic apparatus 1. In addition, FIG. 3 illustrates how the electronic apparatus 1 divides the delivery order into a hot processing area and a cold processing area. The contents shown in FIG. 1 to FIG. 3 are only for exemplifying some embodiments of the present invention, and are not intended to limit the scope of the claimed invention. The electronic apparatus 1 may be various electronic apparatuses with computer functions, such as, but not limited to, personal computers, portable computers, tablet computers, mobile apparatuses, and the like. As shown in FIG. 1, the electronic apparatus 1 may basically comprise a processor 10 and a storage 30, and the processor 10 and the storage 30 are electrically connected to each other. In some embodiments/more specifically, the processor 10 and the storage 30 may be electrically connected directly or indirectly.

The processor 10 may be a programmable specific integrated circuit that is capable of operating, storing, outputting/inputting or the like, and it may receive and process various coded instructions, thereby performing various logical operations and arithmetical operations and outputting corresponding operation results. The processor 10 may be programmed to interpret various instructions and execute various tasks or programs to complete various actions described in the present invention. For example, the processor 10 may comprise a Central Processing Unit (CPU), a Digital Signal Processor (DSP), a Microprocessor, and/or a Microcontroller or the like.

The storage 30 may comprise a primary storage device (e.g., a memory) and may store the instruction set to be read by the processor 10. In some embodiments, in addition to the primary storage device, the storage 30 may further comprise a secondary storage device (e.g., a hard disk, an optical disk), which is connected to the processor 10 through an internal I/O channel and uses a data buffer to transmit data to the primary memory. In some embodiments, in addition to the primary storage device and the secondary storage device, the storage 30 may further comprise a tertiary storage device (e.g., a portable disk and a cloud hard disk), which may also copy data into the secondary storage device.

The storage 30 may be configured to store data generated by the electronic apparatus 1 or data transmitted from the outside to the electronic apparatus 1. For example, as shown in FIG. 1, the storage 30 may be configured to store one or a plurality of delivery orders DO and an inspection configuration file CF, wherein the inspection configuration file CF comprises a plurality of conditional modules, and the plurality of conditional modules correspond to a preset inspection order IO. Each conditional module may correspond to an sequence number, such as a conditional module CM1, a conditional module CM2, a conditional module CM3 and so on in sequence, which forms an inspection order IO. The number and content of conditional modules may be adjusted according to requirements.

As shown in FIG. 2, the processor 10 may be configured to inspect the delivery order DO by using the plurality of conditional modules of the inspection configuration file CF according to the inspection order IO (Action 301). When the delivery order DO passes the inspections of all the plurality of conditional modules (Action 303), the processor 10 may be configured to mark the delivery order DO as “Automatic” and perform dispatch-order automation processing on the delivery order DO (Action 305). In addition, in the case where the delivery order DO fails the inspections of the plurality of conditional modules (Action 303), the processor 10 may be configured to stop using the remaining conditional modules to inspect the delivery order DO (Action 306) and mark the delivery order DO as “Manual” every time when the delivery order DO fails the inspection of any of the plurality of conditional modules in the inspection order. Accordingly, the electronic apparatus 1 can screen out (filter out) the delivery order that is not suitable for automatic dispatch-order generation as early as possible, which not only saves the computing resources of the logistics management system, but also improves the inspection efficiency of the delivery order. In addition, the modulizations of inspection conditions makes codes of inspection operation easy to manage and maintain, and because each conditional module can be developed, tested and maintained independently, the complexity of designing codes of each conditional module is also reduced. In addition, due to the modulizations of inspection conditions, the conditional modules can be easily adjusted or expanded without modifying all the codes on a large scale.

In some embodiments, the processor 10 may inspect the plurality of delivery orders DO stored in the storage 30 according to a fixed or non-fixed cycle.

In some embodiments, the delivery orders DO may correspond to different warehouse categories, and if a warehouse category is specified, then the processor 10 may use the corresponding “Single condition” to inspect the delivery order DO for the specified warehouse category.

Each conditional module may consist of “Compared data”, “Determination method” and “Control value”. The “Compared data” is the data of a certain column in the delivery order DO. The “Determination method” may involve being, for example, equal to, unequal to, less than, greater than, contained in, similar to, dissimilar to, and so on. The “Control value” may be, for example, numbers, words, values returned by function paths, data in columns of delivery orders, regular expressions or the like.

Each conditional module may correspond to any of the following three comparison modes: column-to-value comparison (also known as general comparison), column-to-column comparison, and calling application interface (API) comparison. The column-to-value comparison is to compare the data of a certain column in the delivery order DO with a value. The column-to-column comparison is to compare the data of a certain column in the delivery order DO with the data of another column. For example, the data of the column of “Estimated arrival time” may be compared with the data of the column of “Estimated delivery time,” and it is expected that the former should be later than the latter. The calling application interface comparison is to compare the data of a certain column in the delivery order DO with the value returned by the function path.

Each conditional module may be a single inspection condition or a logical combination of a plurality of inspection conditions. By combining a plurality of inspection conditions into a single conditional module through logical combination, the execution times of the conditional modules can be reduced. The logical combination may be accomplished by logical operations such as “AND”, “OR” or the like.

Referring to FIG. 2, in the dispatch-order automation processing for the delivery order DO, the processor 10 may be configured to determine whether the delivery order DO meets a preparatory condition (Action 307). If the delivery order DO meets the preparatory condition, then the processor 10 may divide the delivery order DO into a hot processing area (Action 308). If the delivery order DO does not meet the preparatory condition, the processor 10 may divide the delivery order DO into a cold processing area (Action 309). Taking FIG. 3 as an example, the processor 10 may divide a delivery order DO1 and a delivery order DO2 that meet a preparatory condition into the hot processing area H1, and divide a delivery order DO3 and a delivery order DO4 that do not meet the preparatory condition into the cold processing area C1. The waste of processing resources of the processor 10 and storage resources of the storage 30 can be avoided by distinguishing between the hot processing area and the cold processing area. In addition, by distinguishing the delivery orders between the cold processing area and the hot processing area, it can be ensured that the delivery order DO in the cold processing area will not affect the operation in the hot processing area, thereby avoiding the reduction of the available efficiency in the hot processing area, and meanwhile ensuring that the delivery order DO in the hot processing area can be ready for automatic dispatch-order generation at any time.

The mechanism of hot and cold processing areas can also produce the following effects: non-real-time processing, batch processing and distributed computing, improved system efficiency and reduced computational complexity of the hot processing area. As for the non-real-time processing, when multiple delivery orders DO arrive at the same time, the electronic apparatus 1 may allow the users not to process all the delivery orders DO immediately. This provides greater operational flexibility, thereby allowing users to choose the delivery timing according to actual needs, rather than being pressured to deal with all the delivery orders immediately. As for the batch processing and distributed computing: the electronic apparatus 1 can effectively execute various algorithms for multiple delivery orders DO at the same time, which can shorten the processing time of a single transaction, improve the overall system efficiency and successfully reduce the burden of real-time computing of the electronic apparatus 1. In addition, when the automatic dispatch-order generation algorithm needs to be executed for multiple delivery orders DO, the electronic apparatus 1 is capable of dispersing the operation load, which is helpful to balance the resource utilization of the electronic apparatus 1, prevent a single transaction from occupying the resources of the electronic apparatus 1 excessively, and further improve the overall efficiency. As for reducing the computational complexity in the hot processing area, the electronic apparatus 1 can automatically filter out the delivery orders DO in the cold processing area, so these delivery orders DO can be automatically ignored by the subsequent complicated automatic dispatch-order generation algorithm, and thus more resources can be allocated to the delivery orders DO in the hot processing area.

In some embodiments, the “Cold processing area” corresponds to the “Delivery order DO that will not be processed temporarily”, while the “Hot processing area” corresponds to the “Delivery order DO for which a dispatch order can be automatically generated at any time”. In addition, the processor 10 may divide its processing resources into cold processing resources and hot processing resources which do not interfere with each other, and the cold processing resources are exclusively used for the “Cold processing area”, while the hot processing resources are exclusively used for the “Hot processing area”. The storage 30 may also divide the storage resources into cold storage resources and hot storage resources which do not interfere with each other, and the cold storage resources are exclusively used for the “Cold processing area”, while the hot storage resources are exclusively used for the “Hot processing area”.

In some embodiments, the above-mentioned preparatory conditions may comprise whether the delivery time/date exceeds the service commitment period. The service commitment period refers to, for example, the “Delivery time/date specified on the transportation terms signed with the customer” or the “Arrival time/date of goods specified by the customer”. When the delivery time/date exceeds the service commitment period, the processor 10 may divide the delivery order DO into the cold processing area C1, and when the delivery time/date does not exceed the service commitment period, the processor 10 may divide the delivery order DO into the hot processing area H1.

In some embodiments, the above-mentioned preparatory condition may comprise whether it is necessary to automatically generate a dispatch order immediately. When it is necessary to automatically generate a dispatch order immediately, the processor 10 may divide the delivery order DO into the hot processing area H1, and when it is not necessary to automatically generate a dispatch order immediately, the processor 10 may divide the delivery order DO into the cold processing area C1.

In some embodiments, the above-mentioned preparatory condition may comprise whether the delivery order DO needs to be consolidated. When the delivery order DO needs to be consolidated, the processor 10 may divide the delivery order DO into the cold processing area C1, and when the delivery order DO does not need to be consolidated, the processor 10 may divide the delivery order DO into the hot processing area H1.

As shown in FIG. 2, the processor 10 will temporarily shelve the delivery order DO that has been divided into the cold processing area C1 (Action 310) to avoid occupying the processing resources of the processor 10. In addition, when the delivery order DO that has been divided into the cold processing area becomes in line with the preparatory condition, the processor 10 may re-divide the delivery order DO that has been divided into the cold processing area into the hot processing area H1. Taking FIG. 3 as an example, when the delivery order DO4 in the cold processing area C1 becomes in line with the preparatory condition, the processor 10 may re-divide the delivery order DO4 into the hot processing area H1.

The cold processing resources of the processor 10 will automatically detect whether all the delivery orders DO that need to be consolidated in the cold processing area C1 have arrived, and re-divide all the delivery orders DO that have arrived into the hot processing area H1. Due to the simple conditions of the delivery order DO in the cold processing area C1, the occupied processing resources of the processor 10 will be very small. By the operation mode of dividing cold and hot areas, the processing resources and storage resources required by the hot processing area H1 can be reduced.

As shown in FIG. 2, for the delivery order DO that has been divided into the hot processing area, the processor 10 may further determine whether to generate a virtual dispatch order for the delivery order DO in the storage 30 (Action 311).

The mechanism of virtual dispatch order can produce the following effects (improvements for computers): efficiency allocation, database storage optimization, and reduction in repeated execution of the dispatch algorithm. As for the efficiency allocation, the resource consumption for the generation of the dispatch order is brought forward before the delivery order DO has reached the dispatch status (i.e., met a dispatch condition). That is, the dispatch order is generated in advance when the electronic apparatus 1 has a low utilization rate, which helps to balance the resource utilization of the electronic apparatus 1 and prevents the operation requiring high efficiency from being concentrated at a certain moment. As for the database storage optimization, the virtual dispatch order will be stored in the temporary storage area first, and then stored in the database after the delivery order DO reaches the dispatch status (i.e., meets a dispatch condition) subsequently. This method can optimize the use of the database and reduce the computational consumption of the dispatching master file. As for the reduction in repeated execution of the dispatch algorithm, since the virtual dispatch order has been stored in the temporary storage area after being generated, the electronic apparatus 1 will not execute the automatic dispatch-order generation algorithm for the delivery order for which the virtual dispatch order has been generated, thereby reducing the repeated computation.

The mechanism of virtual dispatch order can also produce the following effects (improvements for warehouse management): generation of dispatch order in advance, distribution of dispatch at peak hours, warning effect, and dispatch according to the delivery route sequence. As for the generation of dispatch order in advance, before the delivery order DO reaches the dispatch status (i.e., meets a dispatch condition), the electronic apparatus 1 generates a virtual dispatch order in the hot processing area in advance. This concept of generation in advance helps to improve the flexibility of the electronic apparatus 1 so that dispatch-related affairs, such as applying for delivery-related documents, can be handled in advance. If the virtual dispatch order is not automatically generated in advance, then the load in the cold processing area may increase due to the manual generation of the dispatch order. As for the distribution of dispatch at peak hours: the electronic apparatus 1 will automatically detect whether the current dispatch quantity is within the peak hours, and if it is not within the peak hours, then a virtual dispatch order can be automatically generated so that the field operation resources will not be overloaded. If the field operation is overloaded, then it means that the electronic apparatus 1 will face a large amount of resource consumption, and if the dispatch during peak hours can be allocated, then the load of the electronic apparatus 1 at the same time will be shared. As for the warning effect, if too many delivery orders DO are not dispatched, then the electronic apparatus 1 may issue a warning so that the field operators can schedule the dispatch resources, and apply for the delivery documents first after generating the virtual dispatch order. In addition, for customers with low order fill rates, the effect of warning will also be implemented after the virtual dispatch order is generated, which will reduce the probability of re-generating the dispatch order and reduce the resource consumption of the electronic apparatus 1. As for the dispatch according to the delivery route sequence, some cooperative freight forwarders can help deliver goods to multiple destinations, and when the dispatch order is generated in advance, the delivery route sequence of the freight forwarder may be taken into account, so as to fill the same car with goods as much as possible. Manual operation of this part is likely to cause the generation of a wrong dispatch order, and the repeated re-generation of dispatch orders will lead to excessive consumption of the system.

When multiple delivery orders DO are processed in batches, the processor 10 may automatically evaluate the system resources during a dispatch period, and determine whether to generate a virtual dispatch order in advance for one or more delivery orders DO in the storage 30 according to the amount of system resources during the dispatch period. In addition, in the case where it is determined that virtual dispatch orders are to be generated for a plurality of delivery orders DO, the processor 10 may also determine a priority level of generating respective virtual dispatch orders according to a preset condition. By determining the order of generating the virtual dispatch orders according to the priority level, the processing resources of the processor 10 can be used efficiently and flexibly. For example, the preset condition may be, for example, conditions related to delivery types, estimated delivery dates, order statuses, weather statuses, urgent orders, and integration of routes.

As for the delivery types, there are many files to be applied for export-type documents, so the processor 10 may first generate a virtual dispatch order for this type of delivery orders DO, so that field operators can start to apply for relevant files as soon as possible. As for the estimated delivery dates, the processor 10 may compare the estimated delivery date with the current date, and determine the sequence of generating virtual dispatch orders according to the minimum absolute value. In other words, the processor 10 will give priority to the generation of a virtual dispatch order for the delivery order DO corresponding to the smaller value. As for the order statuses, there will be several statuses for orders meeting the conditions of automatic dispatch-order generation, e.g., being distributed, being picked or the like, so the processor 10 will give priority to the generation of a virtual dispatch order for the delivery order with the order status closer to the status preceding the dispatch status. As for the weather statuses, the processor 10 may obtain the weather information of the delivery destination city through the third-party application interface (API), and determine the sequence of generating the virtual dispatch order according to the weather condition of the delivery destination city. As for the urgent orders, the processor 10 may give priority to the generation of a virtual dispatch order for the delivery order DO which is marked as an urgent order. As for the integration of routes, the processor 10 may obtain the transportation route information of the delivery destination through the third-party application interface (API), and determine the sequence of generating the virtual dispatch order according to the conditions of the transportation routes.

If a delivery order is cancelled after a corresponding virtual dispatch order is generated, then the resources used by the processor 10 originally for generating the virtual dispatch order are wasted. Therefore, in some embodiments, the processor 10 can also be configured to determine whether to generate the virtual dispatch order in advance for the delivery order DO in the storage 30 according to the completion rate of a virtual dispatch order of a customer which the delivery order DO corresponds to. In other words, if the probability of giving up an order for a customer is higher than a certain value, then the processor 10 will hold that the customer has a high probability of giving up the order so that goods cannot be delivered smoothly for the delivery order (that is, the completion rate of the virtual dispatch order is too low). Therefore, only when the completion rate of the virtual dispatch order of the customer exceeds a certain preset threshold value (e.g., 80%, 85%, 90%, 95% . . . ), will the processor 10 generate the virtual dispatch order for the delivery order DO of this customer, thus avoiding unnecessary waste of resources of the electronic apparatus 1 to the greatest extent. In addition, such a mechanism can also reduce the possibility of generating useless virtual dispatch orders.

As shown in FIG. 2, if it is determined that it is necessary to generate a virtual dispatch order in advance for a delivery order DO, then the processor 10 will generate the virtual dispatch order in advance for the delivery order DO in the storage 30 (Action 313). Next, the processor 10 will wait until it is determined that a dispatch condition is met (Action 315), and then convert (regularize) the virtual dispatch order into a real dispatch order (Action 316). The contents of the virtual dispatch order are exactly the same as those of the real dispatch order, and as for the conversion, in some embodiments, the processor 10 only converts a state of the virtual dispatch order from virtual to real (for example, changes the numerical value representing the state from 0 to 1). Taking FIG. 3 as an example, the processor 10 divides the delivery order DO1 into the hot processing area H1, generates a virtual dispatch order in advance for the delivery order DO1, and after a dispatch condition is met, converts the virtual dispatch order into a real dispatch order. Then, the warehouse personnel or the goods agent can use a mobile terminal device to obtain the information of the real dispatch order, pick the goods according to the information of the real dispatch order, and then dispatch the picked goods to the customers. In some embodiments, the virtual dispatch order is also divided into the hot processing area H1 and is processed by the hot processing resources of the processor 10 and the hot storage resources of the storage 30. The above dispatch condition means that the delivery order DO reaches the dispatch status (for example, the invoicing of the delivery order is completed).

Also as shown in FIG. 2, if it is determined that there is no need to generate a virtual dispatch order in advance for the delivery order DO, then the processor 10 will wait until it is determined that the same dispatch condition is met (Action 312), and then directly generate a real dispatch order for the delivery order DO in the storage 30 (Action 314). Taking FIG. 3 as an example, the processor 10 divides the delivery order DO2 into the hot processing area H1, and after the dispatch condition is met, directly generates a real dispatch order for the delivery order DO2 in the storage 30. Then, the warehouse personnel or the goods agent can use a mobile terminal device to obtain the information of the real dispatch order, pick the goods according to the information of the real dispatch order, and then dispatch the picked goods to the customers. In some embodiments, the above dispatch condition means that the delivery order DO reaches the dispatch status (for example, the invoicing of the delivery order is completed).

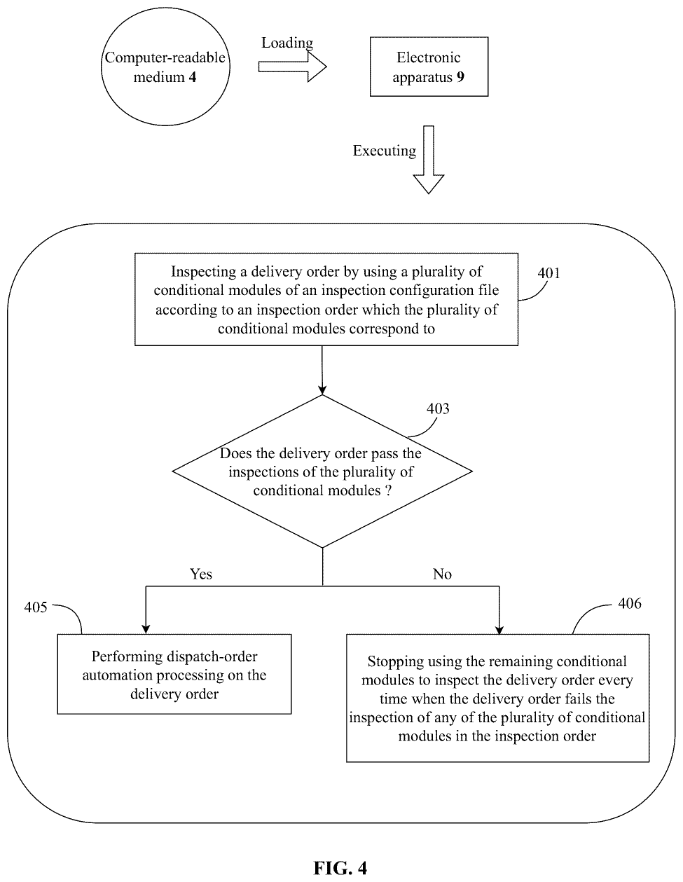

Some embodiments of the present invention relate to a computer-readable medium (which is referred to as a “Computer-readable medium 4” hereinafter). FIG. 4 is a schematic diagram illustrating how the computer-readable medium 4 drives an electronic apparatus 9 to execute instructions, but the contents shown in FIG. 4 are only for exemplifying the embodiment of the present invention, and are not intended to limit the scope claimed in the present invention.

As shown in FIG. 4, the computer-readable medium 4, after being loaded into the electronic apparatus 9, may enable the electronic apparatus 9 to execute the following instructions: inspecting a delivery order by using a plurality of conditional modules of an inspection configuration file according to an inspection order which the plurality of conditional modules correspond to (Instruction 401); performing dispatch-order automation processing on the delivery order when the delivery order passes the inspections of the plurality of conditional modules (Instructions 403 and 405); and stopping using the remaining conditional modules to inspect the delivery order every time when the delivery order fails the inspection of any of the plurality of conditional modules in the inspection order (Instructions 403 and 406). In some embodiments of the computer-readable medium 4, the electronic apparatus 9 may be the electronic apparatus 1 described above.

The computer-readable medium 4 may be a tangible object carrying a computer-readable program, for example, a non-transitory tangible machine-readable medium. The non-transitory tangible machine-readable medium may include: a non-transitory tangible machine-readable medium, a read-only memory (ROM), a flash memory, a floppy disk, a mobile hard disk, a magnetic tape, a network database, a cloud node or other tangible objects. In some embodiments, the computer-readable medium 4 may also be a computer program product, and the computer program product refers to an object loaded with computer-readable programs and not limited to external forms, which is loaded by the electronic apparatus through various network transmissions.

In some embodiments of the computer-readable medium 4, each of the plurality of conditional modules may be a single inspection condition or a logical combination of a plurality of inspection conditions. By combining a plurality of inspection conditions into a single conditional module through logical combination, the execution times of the conditional modules can be reduced.

In some embodiments of the computer-readable medium 4, the electronic apparatus 9 may also be enabled to execute the following instruction: in the dispatch-order automation processing, dividing the delivery order into a hot processing area or a cold processing area depending on whether the delivery order meets a preparatory condition. The waste of computing resources can be avoided by distinguishing between the hot processing area and the cold processing area.

In some embodiments of the computer-readable medium 4, the electronic apparatus 9 may also be enabled to execute the following instructions: waiting for a dispatch condition to be met and then generating a real dispatch order for the delivery order, in the case where the delivery order is divided into the hot processing area.

In some embodiments of the computer-readable medium 4, the electronic apparatus 9 may also be enabled to execute the following instruction: determining whether to generate a virtual dispatch order in advance for the delivery order, in the case where the delivery order is divided into the hot processing area. By generating the virtual dispatch order in advance, computing resources can be prevented from being concentrated in a short time.

For example, the computer-readable medium 4 may also enable the electronic apparatus 9 to execute the following instruction: determining whether to generate the virtual dispatch order for the delivery order according to the system resources of a dispatch period in the case of batch processing. Alternatively, the computer-readable medium 4 may also enable the electronic apparatus 9 to execute the following instruction: determining a priority level of generating the virtual dispatch order according to a preset condition in the case where it is determined that the virtual dispatch order is to be generated for the delivery order. By determining the sequence of generating the virtual dispatch orders according to the priority level, computing resources can be used efficiently and flexibly.

For another example, the computer-readable medium 4 may also enable the electronic apparatus 9 to execute the following instruction: determining whether to generate the virtual dispatch order in advance for the delivery order according to a virtual dispatch-order completion rate of a customer which the delivery order corresponds to. Accordingly, the possibility of generating useless virtual dispatch orders can be reduced.

In some embodiments of the computer-readable medium 4, the electronic apparatus 9 can also be enabled to execute the following instructions: generating the virtual dispatch order in advance for the delivery order, waiting for a dispatch condition to be met, and then converting the virtual dispatch order into a real dispatch order.

In some embodiments of the computer-readable medium 4, the electronic apparatus 9 may also be enabled to execute the following instruction: temporarily shelving the delivery order when the delivery order is divided into the cold processing area. Alternatively, the computer-readable medium 4 may also enable the electronic apparatus 9 to execute the following instruction: re-dividing the delivery order that has been divided into the cold processing area into the hot processing area when the delivery order that has been divided into the cold processing area becomes in line with the preparatory condition. Accordingly, the computing resources can be effectively allocated to the delivery order that needs to be processed at present, and the waste of computing resources can be avoided.

Each embodiment of the computer-readable medium 4 substantially corresponds to at least one embodiment of the electronic apparatus 1. Therefore, all the corresponding embodiments of the computer-readable medium 4 can be fully appreciated by those of ordinary skill in the art simply with reference to the above description of the electronic apparatus 1, even though not all the embodiments of the computer-readable medium 4 are described in detail above.

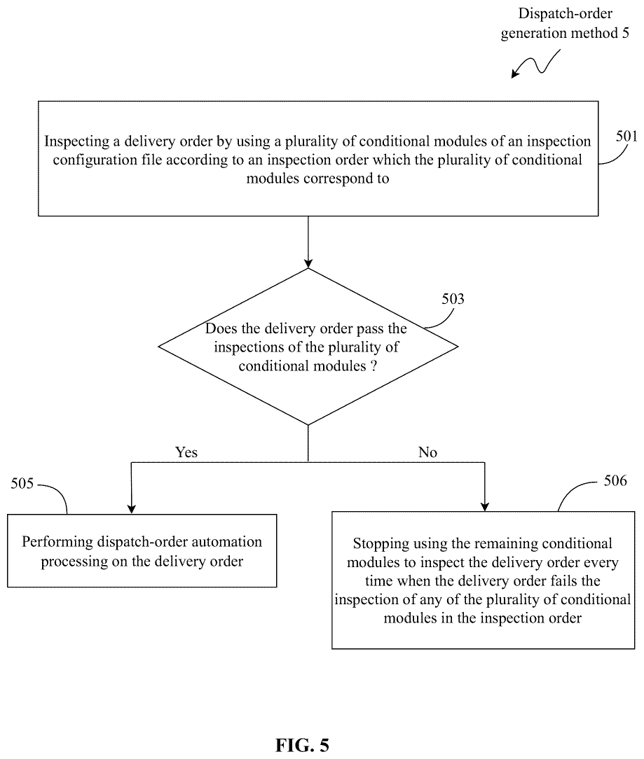

Some embodiments of the present invention relate to a dispatch-order generation method (which is referred to as a “Dispatch-order generation method 5” hereinafter) executed by an electronic apparatus. In some embodiments, the electronic apparatus may be the electronic apparatus 1 described above. FIG. 5 is a schematic view of the dispatch-order generation method 5, but the contents shown in FIG. 5 are only for exemplifying the embodiment of the present invention, and are not intended to limit the scope claimed in the present invention.

As shown in FIG. 5, the dispatch-order generation method 5 may comprise the following steps: inspecting a delivery order by using a plurality of conditional modules of an inspection configuration file according to an inspection order which the plurality of conditional modules correspond to (Step 501); performing dispatch-order automation processing on the delivery order when the delivery order passes the inspections of the plurality of conditional modules (Steps 503 and 505); and stopping using the remaining conditional modules to inspect the delivery order every time when the delivery order fails the inspection of any of the plurality of conditional modules in the inspection order (Steps 503 and 506).

In some embodiments of the dispatch-order generation method 5, each of the plurality of conditional modules may be a single inspection condition or a logical combination of a plurality of inspection conditions. By combining a plurality of inspection conditions into a single conditional module through logical combination, the execution times of the conditional modules can be reduced.

In some embodiments of the dispatch-order generation method 5, the method may further comprise: in the dispatch-order automation processing, dividing the delivery order into a hot processing area or a cold processing area depending on whether the delivery order meets a preparatory condition. The waste of computing resources can be avoided by distinguishing between the hot processing area and the cold processing area.

In some embodiments of the dispatch-order generation method 5, the method may further comprise: waiting for a dispatch condition to be met and then generating a real dispatch order for the delivery order, in the case where the delivery order is divided into the hot processing area.

In some embodiments of the dispatch-order generation method 5, the method may further comprise: determining whether to generate a virtual dispatch order in advance for the delivery order, in the case where the delivery order is divided into the hot processing area. By generating the virtual dispatch order in advance, computing resources can be prevented from being concentrated in a short time.

For example, the dispatch-order generation method 5 may further comprise: determining whether to generate the virtual dispatch order for the delivery order according to the system resources of a dispatch period in the case of batch processing. Alternatively, the dispatch-order generation method 5 may further comprise: determining a priority level of generating the virtual dispatch order according to a preset condition in the case where it is determined that the virtual dispatch order is to be generated for the delivery order. By determining the sequence of generating the virtual dispatch orders according to the priority level, computing resources can be used efficiently and flexibly.

For another example, the dispatch-order generation method 5 may further comprise: determining whether to generate the virtual dispatch order in advance for the delivery order according to a virtual dispatch-order completion rate of a customer which the delivery order corresponds to. Accordingly, the possibility of generating useless virtual dispatch orders can be reduced.

In some embodiments of the dispatch-order generation method 5, the method may further comprise: generating the virtual dispatch order in advance for the delivery order, waiting for a dispatch condition to be met, and then converting the virtual dispatch order into a real dispatch order.

In some embodiments of the dispatch-order generation method 5, the method may further comprise: temporarily shelving the delivery order when the delivery order is divided into the cold processing area. Alternatively, the dispatch-order generation method 5 may further comprise: re-dividing the delivery order that has been divided into the cold processing area into the hot processing area when the delivery order that has been divided into the cold processing area becomes in line with the preparatory condition. Accordingly, the computing resources can be effectively allocated to the delivery order that needs to be processed at present, and the waste of computing resources can be avoided.

Each embodiment of the dispatch-order generation method 5 substantially corresponds to at least one embodiment of the electronic apparatus 1. Therefore, all the corresponding embodiments of the dispatch-order generation method 5 can be fully appreciated by those of ordinary skill in the art simply with reference to the above description of the electronic apparatus 1, even though not all the embodiments of the dispatch-order generation method 5 are described in detail above.

The above embodiments are only examples for illustrating the present invention, and are not intended to limit the scope of the claimed invention. Any other embodiments produced by modifying, changing, adjusting and integrating the above- mentioned embodiments shall all be included in the scope claimed in the present invention as long as they are not difficult for those of ordinary skill in the art to contemplate. The scope of the claimed invention shall be governed by the claims as listed.

What is claimed is:

1. An electronic apparatus for logistics management, comprising:
a storage, being configured to store a delivery order and an inspection configuration file, wherein the inspection configuration file comprises a plurality of conditional modules, and the plurality of conditional modules correspond to an inspection order; and
a processor, being electrically connected with the storage and being configured to:
inspect the delivery order by using the plurality of conditional modules of the inspection configuration file according to the inspection order;
perform dispatch-order automation processing on the delivery order when the delivery order passes inspections of the plurality of conditional modules; and
stop using the remaining conditional modules to inspect the delivery order every time when the delivery order fails an inspection of any of the plurality of conditional modules in the inspection order.

2. The electronic apparatus according to claim 1, wherein each of the plurality of conditional modules is a single inspection condition or a logical combination of a plurality of inspection conditions.

3. The electronic apparatus according to claim 1, wherein the processor is further configured to: in the dispatch-order automation processing, divide the delivery order into a hot processing area or a cold processing area depending on whether the delivery order meets a preparatory condition.

4. The electronic apparatus according to claim 3, wherein the processor is further configured to: wait for a dispatch condition to be met and then generate a real dispatch order for the delivery order in the storage, in a case where the delivery order is divided into the hot processing area.

5. The electronic apparatus according to claim 3, wherein the processor is further configured to: determine whether to generate a virtual dispatch order in advance for the delivery order in the storage, in a case where the delivery order is divided into the hot processing area.

6. The electronic apparatus according to claim 5, wherein the processor is further configured to: determine whether to generate the virtual dispatch order for the delivery order in the storage according to system resources of a dispatch period in a case of batch processing.

7. The electronic apparatus according to claim 6, wherein the processor is further configured to: determine a priority level of generating the virtual dispatch order according to a preset condition in a case where it is determined that the virtual dispatch order is to be generated for the delivery order.

8. The electronic apparatus according to claim 5, wherein the processor is further configured to: determine whether to generate the virtual dispatch order in advance for the delivery order in the storage according to a virtual dispatch-order completion rate of a customer which the delivery order corresponds to.

9. The electronic apparatus according to claim 5, wherein the processor is further configured to: generate the virtual dispatch order in advance for the delivery order in the storage, wait for a dispatch condition to be met, and then convert the virtual dispatch order into a real dispatch order.

10. The electronic apparatus according to claim 3, wherein the processor is further configured to: temporarily shelve the delivery order when the delivery order is divided into the cold processing area.

11. The electronic apparatus according to claim 10, wherein the processor is further configured to: re-divide the delivery order that has been divided into the cold processing area into the hot processing area when the delivery order that has been divided into the cold processing area becomes in line with the preparatory condition.

12. A non-transitory computer-readable medium, after being loaded into an electronic apparatus, enabling the electronic apparatus to execute the following instructions, comprising:
inspecting a delivery order by using a plurality of conditional modules of an inspection configuration file according to an inspection order which the plurality of conditional modules correspond to;
performing dispatch-order automation processing on the delivery order when the delivery order passes inspections of the plurality of conditional modules; and
stopping using the remaining conditional modules to inspect the delivery order every time when the delivery order fails an inspection of any of the plurality of conditional modules in the inspection order.

13. The non-transitory computer-readable medium according to claim 12, wherein each of the plurality of conditional modules is a single inspection condition or a logical combination of a plurality of inspection conditions.

14. The non-transitory computer-readable medium according to claim 12, further comprising enabling the electronic apparatus to execute the following instruction: in the dispatch-order automation processing, dividing the delivery order into a hot processing area or a cold processing area depending on whether the delivery order meets a preparatory condition.

15. The non-transitory computer-readable medium according to claim 14, further comprising enabling the electronic apparatus to execute the following instructions: waiting for a dispatch condition to be met and then generating a real dispatch order for the delivery order, in a case where the delivery order is divided into the hot processing area.

16. The non-transitory computer-readable medium according to claim 14, further comprising enabling the electronic apparatus to execute the following instruction: determining whether to generate a virtual dispatch order in advance for the delivery order, in a case where the delivery order is divided into the hot processing area.

17. The non-transitory computer-readable medium according to claim 16, further comprising enabling the electronic apparatus to execute the following instruction: determining whether to generate the virtual dispatch order for the delivery order according to system resources of a dispatch period in a case of batch processing.

18. The non-transitory computer-readable medium according to claim 17, further comprising enabling the electronic apparatus to execute the following instruction: determining a priority level of generating the virtual dispatch order according to a preset condition in a case where it is determined that the virtual dispatch order is to be generated for the delivery order.

19. The non-transitory computer-readable medium according to claim 16, further comprising enabling the electronic apparatus to execute the following instruction: determining whether to generate the virtual dispatch order in advance for the delivery order according to a virtual dispatch-order completion rate of a customer which the delivery order corresponds to.

20. The non-transitory computer-readable medium according to claim 16, further comprising enabling the electronic apparatus to execute the following instructions: generating the virtual dispatch order in advance for the delivery order, waiting for a dispatch condition to be met, and then converting the virtual dispatch order into a real dispatch order.

21. The non-transitory computer-readable medium according to claim 14, further comprising enabling the electronic apparatus to execute the following instruction: temporarily shelving the delivery order when the delivery order is divided into the cold processing area.

22. The non-transitory computer-readable medium according to claim 21, further comprising enabling the electronic apparatus to execute the following instruction: re-dividing the delivery order that has been divided into the cold processing area into the hot processing area when the delivery order that has been divided into the cold processing area becomes in line with the preparatory condition.

23. A dispatch-order generation method executed by an electronic apparatus, comprising:
inspecting a delivery order by using a plurality of conditional modules of an inspection configuration file according to an inspection order which the plurality of conditional modules correspond to;
performing dispatch-order automation processing on the delivery order when the delivery order passes inspections of the plurality of conditional modules; and
stopping using the remaining conditional modules to inspect the delivery order every time when the delivery order fails an inspection of any of the plurality of conditional modules in the inspection order.

24. The dispatch-order generation method according to claim 23, wherein each of the plurality of conditional modules is a single inspection condition or a logical combination of a plurality of inspection conditions.

25. The dispatch-order generation method according to claim 23, further comprising: in the dispatch-order automation processing, dividing the delivery order into a hot processing area or a cold processing area depending on whether the delivery order meets a preparatory condition.

26. The dispatch-order generation method according to claim 25, further comprising: waiting for a dispatch condition to be met and then generating a real dispatch order for the delivery order, in a case where the delivery order is divided into the hot processing area.

27. The dispatch-order generation method according to claim 25, further comprising: determining whether to generate a virtual dispatch order in advance for the delivery order, in a case where the delivery order is divided into the hot processing area.

28. The dispatch-order generation method according to claim 27, further comprising: determining whether to generate the virtual dispatch order for the delivery order according to system resources of a dispatch period in a case of batch processing.

29. The dispatch-order generation method according to claim 28, further comprising: determining a priority level of generating the virtual dispatch order according to a preset condition in a case where it is determined that the virtual dispatch order is to be generated for the delivery order.

30. The dispatch-order generation method according to claim 27, further comprising: determining whether to generate the virtual dispatch order in advance for the delivery order according to a virtual dispatch-order completion rate of a customer which the delivery order corresponds to.

31. The dispatch-order generation method according to claim 27, further comprising: generating the virtual dispatch order in advance for the delivery order, waiting for a dispatch condition to be met, and then converting the virtual dispatch order into a real dispatch order.

32. The dispatch-order generation method according to claim 25, further comprising: temporarily shelving the delivery order when the delivery order is divided into the cold processing area.

33. The dispatch-order generation method according to claim 32, further comprising: re-dividing the delivery order that has been divided into the cold processing area into the hot processing area when the delivery order that has been divided into the cold processing area becomes in line with the preparatory condition.
